(19) United States
(12) Patent Application Publication
(10) Pub. No.: US 2017/0068810 A1
(43) Pub. Date: Mar. 9, 2017

(54) METHOD AND APPARATUS FOR INSTALLING AN APPLICATION PROGRAM BASED ON AN INTELLIGENT TERMINAL DEVICE

(71) Applicant: BEIJING QIHOO TECHNOLOGY COMPANY LIMITED, Beijing (CN)

(72) Inventors: Tong YAO, Beijing (CN); Yi DING, Beijing (CN)

(21) Appl. No.: 15/120,378

(22) PCT Filed: Dec. 11, 2014
(86) PCT No.: PCT/CN2014/093595

§ 371 Date: Aug. 19, 2016

(30) Foreign Application Priority Data
Feb. 21, 2014 (CN) 201410060381.2
Feb. 21, 2014 (CN) 201410060681.0
Feb. 21, 2014 (CN) 201410060683.X

(51) Int. Cl. G06F 21/44; G06F 21/51; G06F 9/445

(52) U.S. Cl. CPC G06F 21/44; G06F 8/61; G06F 21/51

(57) ABSTRACT

The invention discloses a method and apparatus for installing an application program based on an intelligent terminal device. The method comprises: during installation of an application program, after it is monitored that the application program needs to read a configuration information file, loading an application program authorization permission list interface set for the application program to be installed, wherein the application program authorization permission list interface is an interface for modifying an application program authorization permission list, comprises one or more behavior permission selectively authorized by a user for the application program to be installed, and records modifications to the application program authorization permission list(101); and updating the behavior permissions of the application program according to the record of the modifications to the application program authorization permission list after the installation of the application program is completed(102). By applying the method and apparatus, the user security may be improved.

### FIELD OF THE INVENTION

The invention relates to mobile intelligent terminal operating system platform technologies, and in particular, to a method and apparatus for installing an application program based on an intelligent terminal device.

### BACKGROUND OF THE INVENTION

The Android platform is a Linux based open source mobile phone operating system platform, consists of an operating system, a user interface and application programs, and is completely open to third party application programs. Because of the openness of the Android platform, an application program developer has a greater degree of freedom when developing an application program, therefore, it attracts many application program developers, and the application program developers also develop and provide a large number of Android application programs based on the Android platform. The installation package of such an application program is released in a form called APK (Android Package), and the running of the application program is implemented by installing the Android installation package, such that more and more application programs may be hosted on the Android platform. As the most popular mobile operating system platform in the world, the Android platform has already covered billions of mobile terminals and a multitude of application programs.

At the beginning of its design, the Android platform designed a granted behavior permission based secure access policy, and when a user installs an application program, if the application program involves an operation relates to user security, for example, an operation of reading user privacy information, or an operation that may result in loss of user fees, it requires the user to conduct behavior authorization for the application program before it proceeds. For example, if after installation, an application program needs to perform the operation of reading user privacy information, such as sending a short message, accessing contact data, reading memory card data, or the like, and an operation that increases the user fees, such as using a network connection, or the like, it needs to apply to the user for corresponding behavior permission during installation, that is, during the installation of the application program, a statement of behavior permissions that need user authorization is displayed to the user via a mobile terminal, and thereby the user determines whether to grant an access permission of performing a user security operation to the application program.

During installation of an application program, because of the secure access policy of the Android platform, a user can only grant behavior permissions applied for by the application program in general when installing the application program, that is, the intelligent terminal device operating system grants behavior permissions in general. Therefore, when an application program is installed, after behavior permission services applied for by the application program are displayed to a user, the user either accepts all the behavior permission services applied for by the application program to proceed to install the application program, or can only cancel the installation of the application program and exit the installation of the application program. For example, when a user installs a KC network phone application program, since behavior permissions related to user security information need to be obtained, the Android platform displays security related behavior permissions that need user authorization on a display interface of a mobile terminal according to the behavior permission based secure access policy, for example, reading the state and ID of the mobile terminal, intercepting an outgoing call, directly calling a phone number, editing an SMS or MMS, and sending text information, audio recordings and precise GPS location information, etc. If the user authorizes the KC network phone application program to perform all the above security operations, it may continue with the installation by clicking the Next control of the display interface. Thus, after the KC network phone application program is installed, the KC network phone application program will have permission to obtain user security information such as the audio recording information and the precise GPS location information, etc. of the user. If the user does not authorize the KC network phone application program to perform all the above security operations, he can exit the current installation of the KC network phone application program by clicking the Cancel control of the display interface.

Recently, utilizing the characteristic that the Android platform can only grant behavior permissions to an application program in general, malicious application programs for the Android platform increase significantly. In applying for user authorized behavior permissions, a malicious application program increases a plurality of behavior permissions that affect the user security, for example, behavior permissions of sending a short message, reading contacts, networking, recording audio, and reading the precise GPS location information of a user, and the like, binds to behavior permissions needed for the malicious application program to run normally, and attracts users to install with various attractive names, functions and applications, and meanwhile, when displaying security related behavior permissions that need user authorization on the display interface of a mobile terminal, places the increased behavior permissions that affect the user security at a location that a user is less concerned about, and thereby continues with the installation by the user clicking the Next control of the display interface. However, once the malicious application program is installed and run, it implies that the user grants all the behavior permissions applied for by the malicious application program, which causes the user security to be confronted with significant risks, and yet the malicious application program achieves goals of stealing user privacy, malicious charging, and the like by its installation by the user. Further, even if the user doubts about some of the behavior permissions applied for by the malicious application program, he has no choice but to give up the installation.

To reduce potential security risks brought to a user by a malicious application program, the existing Android platform provides a secure application program for providing functions of active defense and behavior permission management, that is, by running the secure application program, the user may select behavior permissions that need to be disabled of individual application programs, in other words, by running the secure application program, the super administrator permissions (i.e., root permissions) may be provided to the user, such that the user may utilize the super administrator permissions to modify and update behavior permissions of individual application programs, thereby when an application program is running, it does not enjoy the behavior permissions granted by the user during installation of the application program, and thereby in a subsequent application, it may be avoided that the application program poses a threat to the user security. However, such an approach can not effectively avoid, in a period of time after the user installs the application program and before he sets disabled behavior permissions via the secure application program, the potential security risks brought to the user when the application program is running, the user security information can still be stolen or leaked out in this period of time, thereby bringing about a loss to the user and causing the user security to be lowered. Further, some application programs do have good experience points. However, since the user worries that the behavior permissions applied for by the application program might lead to leakage of personal privacy information, he will ultimately choose not to install the application program, which thus not only reduces the user's service experiences, but also brings great economic losses to the application program developer.

### SUMMARY OF THE INVENTION

In view of the above problems, the invention is proposed to provide a method, apparatus, computer program and computer readable medium for installing an application program based on an intelligent terminal device, which overcome the above problems or at least partly solve the above problems.

According to an aspect of the invention, there is provided a method for installing an application program based on an intelligent terminal device, comprising:

during installation of an application program, after it is monitored that the application program needs to read a configuration information file, loading an application program authorization permission list interface set for the application program to be installed, wherein the application program authorization permission list interface is an interface for modifying an application program authorization permission list, comprises one or more behavior permission selectively authorized by a user for the application program to be installed, and records modifications to the application program authorization permission list; and

updating the behavior permissions of the application program according to the record of the modifications to the application program authorization permission list after the installation of the application program is completed.

According to another aspect of the invention, there is provided an apparatus for installing an application program based on an intelligent terminal device, comprising: a monitoring module, a loading module and a permission configuration module, wherein

the monitoring module is configured to notify the loading module after it is monitored that an application program needs to read a configuration information file during installation of the application program;

the loading module is configured to load an application program authorization permission list interface set for the application program to be installed according to the received notification, wherein the application program authorization permission list interface is an interface for modifying an application program authorization permission list, comprises one or more behavior permission selectively authorized by a user for the application program to be installed, and records modifications to the application program authorization permission list; and

the permission configuration module is configured to update the behavior permissions of the application program according to the record of the modifications to the application program authorization permission list after the installation of the application program is completed.

According to an aspect of the invention, there is provided a method for installing an application program based on an intelligent terminal device, comprising:

installing an application program, and after it is monitored that the application program needs to read a configuration information file, loading an application program authorization permission list interface set for the application program to be installed, wherein the application program authorization permission list interface is an interface for modifying an application program authorization permission list, and comprises one or more behavior permission selectively authorized by a user for the application program to be installed; and

configuring behavior permissions of the application program according to the authorized behavior permissions comprised in the loaded application program authorization permission list interface, and completing the installation of the application program.

According to another aspect of the invention, there is provided an apparatus for installing an application program based on an intelligent terminal device, comprising: a monitoring module, a loading module and a permission configuration module, wherein

the monitoring module is configured to install an application program, and notify the loading module after it is monitored that the application program needs to read a configuration information file;

the loading module is configured to load an application program authorization permission list interface set for the application program to be installed according to the received notification, wherein the application program authorization permission list interface is an interface for modifying an application program authorization permission list, and comprises one or more behavior permission selectively authorized by a user for the application program to be installed; and

the permission configuration module is configured to configure behavior permissions of the application program according to the authorized behavior permissions comprised in the loaded application program authorization permission list interface, and complete the installation of the application program.

According to an aspect of the invention, there is provided a method for installing an application program based on an intelligent terminal device, comprising:

installing an application program, and after it is monitored that the application program needs to read a configuration information file, loading an application program authorization permission list preset by a user for the application program to be installed, wherein the application program authorization permission list comprises one or more behavior permission selectively authorized by the user for the application program to be installed; and

configuring behavior permissions of the application program according to the authorized behavior permissions comprised in the loaded application program authorization permission list, and completing the installation of the application program.

According to another aspect of the invention, there is provided an apparatus for installing an application program based on an intelligent terminal device, comprising: a monitoring module, a loading module and a permission configuration module, wherein

the monitoring module is configured to install an application program, and notify the loading module after it is monitored that the application program needs to read a configuration information file;

the loading module is configured to load an application program authorization permission list preset by a user for the application program to be installed according to the received notification, wherein the application program authorization permission list comprises one or more behavior permission selectively authorized by the user for the application program to be installed; and

the permission configuration module is configured to configure behavior permissions of the application program according to the authorized behavior permissions comprised in the loaded application program authorization permission list, and complete the installation of the application program.

According to another aspect of the invention, there is provided a computer program comprising a computer readable code which causes the method for installing an application program based on an intelligent terminal device to be performed, when said computer readable code is run by an electronic device.

According to still another aspect of the invention, there is provided a computer readable medium storing the computer program as described above.

The method and apparatus for installing an application program based on an intelligent terminal device according to the invention may, by completing installation of an application program, reselecting and determining permissions that may be granted to the application program and permissions that are forbidden to be granted, thereby updating behavior permissions granted to the application program with respect to the intelligent terminal device operating system during the installation, or the method and apparatus for installing an application program based on an intelligent terminal device according to the invention may, by selecting and determining behavior permissions that may be granted to an application program and behavior permissions that are forbidden to be granted before installing the application program, and configuring permissions authorized in advance by a user for the application program when installing the application program, solves the technical problem that a user may forbid an application program to obtain authorization of sensitive behavior permissions before the application program is installed, such that the application program employs authorized permissions preset by the user to conduct corresponding access after the installation, and achieves the beneficial effects that not only that the user normally uses the service functions provided by the application program can be ensured, but also the user security can be guaranteed effectively.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings of the embodiments are only for the purpose of showing the preferred embodiments, and are not considered to be limiting to the invention. And throughout the drawings, like reference signs are used to denote like components. In the drawings:

FIG. 1 shows a flow of a method for installing an application program based on an intelligent terminal device of an embodiment of the invention;

FIG. 2 shows another flow of a method for installing an application program based on an intelligent terminal device of an embodiment of the invention;

FIG. 3 shows still another flow of a method for installing an application program based on an intelligent terminal device of an embodiment of the invention;

FIG. 4 shows a structure of an apparatus for installing an application program based on an intelligent terminal device of an embodiment of the invention;

FIG. 5 shows a block diagram of an electronic device for performing a method according to the invention; and

FIG. 6 shows a schematic diagram of a storage unit for retaining or carrying a program code implementing a method according to the invention.

### DETAILED DESCRIPTION OF THE INVENTION

In the following exemplary embodiments of the disclosure will be described in more detail with reference to the accompanying drawings. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and in order to be able to fully convey the scope of the disclosure to those skilled in the art.

In the prior art, when an application program is installed based on an intelligent terminal device, due to the characteristic that behavior permissions applied for by the application program can only be granted in general, a user can not select a behavior permission service according to his own security needs, and if he needs to install an application program, he can only be forced to accept all the behavior permissions applied for by the application program in behavior permission services that need the user to authorize displayed on the display interface of a mobile terminal to continue to install the application program. That is, by default, the user authorizes all the behavior permissions applied for by the application program, and thereby continues with the installation by the user clicking the Next control of the display interface. However, once the application program is installed and run, it implies that the user grants all the behavior permissions applied for by the application program, which causes the user security to be confronted with significant risks. However, the functions of active defense and permission management provided by a secure application program still can not effectively avoid potential security risks brought to the user due to running of an application program after the user installs the application program and before he set disabled behavior permissions via the secure application program, which causes the user security to be lowered.

Behavior permissions applied for by an existing application program to a user and configuration information of the application program are carried in a configuration information file of the application program. Since the configuration information file is generated by an application program developer via a signature, the behavior permissions applied for by the application program can not be changed by parsing the configuration information file and modifying the parsed configuration information file. In an embodiment of the invention, there is proposed a method for installing an application program based on an intelligent terminal device, wherein by obtaining in advance behavior permissions applied for by individual application programs and selectively authorizing behavior permissions applied for by an application program by a user before the application program is installed, the user is enabled to perform corresponding selection and authorization in the behavior permissions applied for by the application program to generate an application program authorization permission list according to his own needs of the functions of the application program and the security considerations, and during installation of the application program, trigger the application program to take the generated application program authorization permission list as the behavior permissions that are granted after the application program is installed, which thus not only may ensure that the user normally uses the service functions provided by the application program, but also may guarantee the user security effectively. Or, by updating behavior permissions granted to the application program with respect to the intelligent terminal device operating system during the installation via the application program authorization permission list, such that the application program takes the generated application program authorization permission list as the behavior permissions that are granted after the application program is installed, which thus not only may ensure that the user normally uses the service functions provided by the application program, but also may guarantee the user security effectively.

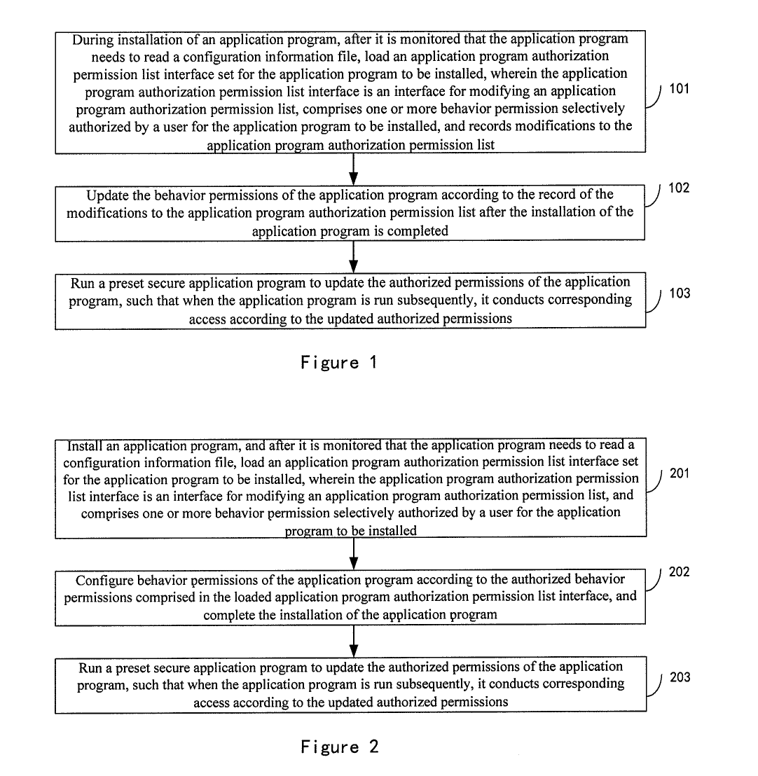

FIG. 1 shows a flow of a method for installing an application program based on an intelligent terminal device of an embodiment of the invention, wherein the running platform of the intelligent terminal device comprises, but is not limited to, the Android platform. With reference to FIG. 1, the flow comprises the following steps 101-102.

At the step 101, during installation of an application program, after it is monitored that the application program needs to read a configuration information file, an application program authorization permission list interface set for the application program to be installed is loaded, wherein the application program authorization permission list interface is an interface for modifying an application program authorization permission list, comprises one or more behavior permission selectively authorized by a user for the application program to be installed, and records modifications to the application program authorization permission list.

At this step, loading an application program authorization permission list interface set for the application program to be installed comprises the following steps A11-A13.

At A11, the application program file package for installing the application program is parsed, to obtain the application program identification in the application program file package.

At this step, by parsing the application program file package, the application program identification for uniquely marking the application program may be obtained.

At A12, a preset application program authorization permission list library is queried according to the obtained application program identification, to obtain an application program authorization permission list corresponding to the application program identification.

At this step, in the preset application program authorization permission list library, certain application program corresponds to an application program authorization permission list, and the application program authorization permission list takes the application program identification as a mark. In each application program authorization permission list are stored behavior permissions authorized in advance by a user for the application program. If the list has no behavior permissions corresponding to the application program, then there is no specific permission suggestion, however, the user still can authorize or disable all the permissions.

In an embodiment of the invention, the preset application program authorization permission list library may be obtained by the following approach:

performing the following steps B11 and B12 for each application program.

At B11, during installation of the application program, after it is monitored that the application program reads a configuration information file, behavior permissions applied for by the application program with respect to the intelligent terminal device operating system in the configuration information file are collected and obtained.

At this step, permission authorization needs to be conducted for an application program in advance before the application program is installed. As an optional embodiment, an application program file package may be obtained via the official download website of the application program, or also the application program file package provided by a formal application program provider may be obtained from other approach. For example, the application program file package is obtained from an application program operator website. That is, the application program file package may be uploaded by an application program developer, or also may be uploaded by an application program operator, or also may be a legitimate copy of application program file package uploaded via other channel, as long as a legitimate copy of application program file package can be obtained. As such, by obtaining the application program file package via a formal approach, the legality and rationality of permissions applied for by the application program may be ensured, avoiding that after the application program file package is modified illegally via other approach, the illegally modified application program maliciously applies for more behavior permissions involving the user security.

After downloading and obtaining the application program file package, behavior permissions need to be applied for by the application program with respect to the intelligent terminal device operating system may be obtained by parsing the configuration information file in the application program file package.

In an embodiment of the invention, under the Android platform, the application program file package is an APK file. Each APK file comprises binary code information, resource information, a configuration information file, etc. of an application program. The configuration information file is an AndroidManifest.xml file in the APK file, must be defined and comprised by each application program, and it describes information of the name, version, permissions, referenced library files, etc. of an application program. In a practical application, parsing the configuration information file in an application program file package comprises: decompressing an application program file based on the Android platform, obtaining an encrypted configuration information file described by a global variable from the decompressed application program file, namely, an AndroidManifest.xml file, and decrypting the encrypted configuration information file to obtain a decrypted original configuration information file: an AndroidManifest.xml file; and scanning the permission description portion in the AndroidManifest.xml file, to obtain a list of behavior permissions applied for by the application program, wherein the behavior permissions comprised in the list of behavior permissions are behavior permissions applied for by the application program.

The form of the statement of the behavior permissions of the application program in the AndroidManifest.xml file is as follows:

File name: AndroidManifest.xml

<uses-permission android:name=“use permissions”/>

As an optional embodiment, in the above parsing flow, the Extensible Markup Language (XML) file parser in Java may be used to parse the permission description portion in the AndroidManifest.xml file to obtain the list of behavior permissions applied for by the application program. Of course, it may also be possible to use other XML parser, or use other programming language, for example, a programming language such as C/C++, python, etc., to develop an XML parser, to parse the AndroidManifest.xml file to obtain the list of behavior permissions applied for by the corresponding application program.

At B12, an application program authorization permission list stored in the application program authorization permission list library is generated according to authorized behavior permissions selected by a user from the obtained behavior permissions applied for by the application program.

At this step, from behavior permissions applied for by each application program, according to his own business needs and the security considerations, as an optional embodiment, a user may conduct permission authorization for each application program respectively on the installation interface corresponding to the configuration information file read by the application program during installation of the application program, and according to authorized behavior permissions selected for each application program, the intelligent terminal device operating system generates an application program authorization permission list corresponding to the application program, i.e., which records behavior permissions selected and authorized by a user on the installation interface for subsequent loading and application, wherein the configuration information file comprises behavior permissions granted by the intelligent terminal device operating system to an application program. Each application program corresponds to an application program authorization permission list, and the application program authorization permission list is marked with an application program identification. In an embodiment of the invention, a plurality of application program authorization permission lists constitute an application program authorization permission list library, and an application program authorization permission list not only comprises one or more behavior permission authorized by a user for an application program, but also comprises one or more behavior permission forbidden to be authorized by the user for the application program, and a behavior permission subsequently used for updating the application program meets the display of the application program authorization permission list interface. That is, for a behavior permission in an application program authorization permission list, its attribute is authorized or forbidden to be authorized, and authorized behavior permissions comprised in the application program authorization permission list are part of behavior permissions granted by the intelligent terminal device operating system. If a behavior permission that is applied for is in the application program authorization permission list, and its attribute is authorized, the behavior permission access applied for by the application program is allowed; and if a behavior permission that is applied for is in the application program authorization permission list, and its attribute is forbidden to be authorized, the behavior permission access applied for by the application program is denied.

As an optional embodiment, in order to facilitate the authorization and selection operation performed by the user on the behavior permissions, before the user selects an authorized permission from the obtained behavior permissions applied for by the application program, the method may further comprise:

displaying the obtained behavior permissions applied for by the application program.

At this step, an authorization setting interface (the application program authorization permission list interface) may be further provided to the user, the behavior permissions applied for by the application program are displayed on the authorization setting interface, and the user makes authorization selection of a displayed behavior permission on the authorization setting interface. Thus, the user may conveniently select a needed behavior permission for authorization by means of the visual authorization setting interface.

As a further optional embodiment, to improve the user's understanding of the behavior permissions applied for by the application program, the method may further comprise:

classifying the obtained behavior permissions applied for by the application program.

At this step, the obtained behavior permissions can be classified into privacy permissions and other permissions for each application program, wherein, for the privacy permissions, it is necessary to remind the user to pay special attention due to involvement of the user's privacy, whereas for the other permissions, the user may, according to the application by the application program, grant the permissions to it without paying much attention.

In an embodiment of the invention, a privacy permission comprises, but is not limited to, the following information: sending a short message (android.permission.SEND_SMS), access to the internet (android.permission.INTERNET), reading a short message (android.permission.READ_SMS), writing a short message (android.permission.WRITE_SMS), reading contacts (android.permission.READ_CONTACTS), writing contacts (android.permission.WRITE_CONTACTS), calling a phone (android.permission.CALL_PHONE), writing system settings (android.permission.WRITE_SYNC_SETTINGS), reading location information, recording audio and reading audio recording information. Each privacy permission corresponds to a function. For example, for the permission to send a short message, the corresponding function is SmsManager.sendTextMessage, SmsManager.sendDataMessage, SmsManager.sendMultipartTextMessage, etc.

For the privacy permissions, they may be further divided into essential permissions and nonessential permissions. Therein, an essential permission is a behavior permission that is essential to the running of an application program and authorized by a user. If the authorized behavior permission is lacked, the application program can not be run normally. If the user needs to install the application program, he must authorize all the essential permissions applied for by the application program, otherwise, the installation can not be done. A nonessential permission is a behavior permission that is needed by an application program and authorized by a user, however, it is optional and will not affect the running of the application program. If the behavior permission is not authorized by the user, this will not affect the installation and the running of the application program. For example, the essential permissions may comprise: writing contacts, calling a phone, and the like, and the nonessential permissions may comprise: reading location information, access to the internet, reading audio recording information, and the like.

As an optional embodiment, for a nonessential permission, prompt information of the nonessential permission is further displayed to the user on the authorization setting interface. The prompt information may be: a nonessential permission, recommend to cancel, or the permission is an optionally authorized item, authorize it according to your own security policy, or the like. That is, the user is suggested to carefully select a behavior permission granted to an application program based on his own privacy security considerations when authorizing nonessential permissions.

As a further optional embodiment, for essential permissions, verification can be further performed to determine whether all the essential permissions are essential to the running of an application program, that is, verification of legality and rationality is performed on the essential permissions applied for by the application program. An approach for verification may be utilizing an isolation sandbox and/or static code analysis and/or automatic code feature scanning, etc., to determine whether each behavior permission in the essential permissions is an indispensable behavior permission necessary for the application program to be run, and if not, the behavior permission is removed from the essential permissions and displayed to the user as a nonessential permission. Therein, by applying the static code analysis, the security risks and vulnerabilities existing in the essential permissions applied for by each application program can be found and located rapidly and accurately. And, by using the virtual machine technology, the isolation sandbox clones a certain partition or all partitions of a hard disk in the Android platform via a virtual machine, and forms a shadow, which is called a shadow mode. The shadow mode has the same architecture and functions as the Android platform system, and a user may run an application program in the shadow mode. Any operation of an application program, for example, deleting & modifying a file, installing & testing various application programs (including rogue application programs, virus application programs), is wrapped by the isolation sandbox, interception of user privacy information by a malicious application program is restricted within the isolation sandbox, and as soon as the isolation sandbox is closed, operations that endanger the Android platform can be erased. Therefore, by monitoring behaviors of accessing user data by an application program via the isolation sandbox approach, it may be determined whether the essential permissions applied for by the application program involve permission abuse, that is, whether the application program has applied to the user for a behavior permission that should not be applied for for various purposes. If the application program has applied for an additional behavior permission by way of an essential permission, which may lead to leakage of the user privacy information, the behavior permission that has been applied for additionally needs to be removed from the essential permissions. For example, if a stand-alone game application program has applied for a behavior permission to read a user's phone book, the reading a user's phone book might belong to a behavior permission that the stand-alone game application program should not applied for, which thus enhances the security of the user privacy. Utilizing an approach of isolation sandbox, static code analysis, and automatic code feature scanning, etc. to perform verification of legality and rationality on essential permissions applied for by an application program is a well-known technique, of which a detailed description will be omitted here.

As such, by classifying behavior permissions applied for by an application program into privacy permissions and other permissions, such that a user pays attention to a privacy permission involved therein, and thereby considers whether he needs to grant the permission to the application program, the user privacy security is guaranteed; further, by dividing the privacy permissions into essential permissions and nonessential permissions, such that for a nonessential permission, a user tries to avoid its authorization based on his own security policy, the user privacy security is thus improved; and moreover, for an essential permission, its verification of legality and rationality may remove behavior permissions additionally applied for by a malicious application program, the user security is guaranteed to the greatest extent.

At A13, the obtained application program authorization permission list is loaded on the installation interface, to generate the application program authorization permission list interface.

At this step, the loaded application program authorization permission list interface is employed to replace the installation interface of the application program provided by the intelligent terminal device operating system during its installation.

Loading an application program authorization permission list interface set for the application program to be installed comprises: jumping and directing the installation interface provided by the intelligent terminal device operating system to the application program authorization permission list interface via a hook, and ending the jumping of the installation interface provided by the intelligent terminal device operating system after confirming or completing modification to the application program authorization permission list. In particular, it can find out a class and interface of a hook that needs to be inserted in the installation implementation of the application program in the source code of the framework level of the Android platform, wherein such a class and interface are a class and interface involving the user privacy information. By analyzing and modifying the source code of the class and interface, the class and interface of the hook inserted when the configuration information file needs to be read are made to be directed to the application program authorization permission list preset by the embodiment of the invention, not to the configuration information file in the application program file package. A preset program code segment is run, the application program authorization permission list is loaded to the current installation interface to generate the application program authorization permission list interface, and after completion of the application program authorization permission list interface, operations after reading the configuration information file of the application program are directed to, such that the operations after completion of the application program authorization permission list interface are the same as the existing operations after reading the configuration information file of the application program. That is, in an interface after behavior permissions of the application program are configured according to authorized behavior permissions comprised in the loaded application program authorization permission list interface, the direction of the class and interface of the hook that the Next control needs to correspondingly insert is set, wherein the direction is the same as that of the class and interface of the hook that the Next control needs to correspondingly insert displayed after the application program reads the configuration information file to perform behavior permission configuration of the application program. The implementation of modification to the source code according to the functions described by the embodiment of the invention is a well-known technique, of which the detailed description will be omitted here. In a practical application, the original default application program installer of the Android platform is replaced by way of modifying the source code, thereby implementing the loading of the application program authorization permission list of the embodiment of the invention, wherein an approach of replacing the original installer of the Android platform comprises, but is not limited to, the following: selecting by a user a new installer as the default installer of the Android platform, directly replacing the original application program installation solution of the Android platform on a Rooted mobile terminal, and replacing the original application program installation solution of the Android platform in the ROM of a mobile terminal.

At the step 102, the behavior permissions of the application program are updated according to the record of the modifications to the application program authorization permission list after the installation of the application program is completed.

At this step, after the application program installer configures the behavior permissions of the application program according to the loaded application program authorization permission list, the subsequent installation flow is a well-known technique, of which the detailed description will be omitted here.

In an embodiment of the invention, during the installation of the application program, for example, the application program authorization permission list interface displayed to the user may be displayed in rows, and each of the rows is in particular sequentially as follows: This application program has applied for 11 permissions, and whether install this application program? (a first row); 3 privacy permissions (nonessential permissions, recommend to cancel) (a second row); Reading location information (a third row; a checkbox control is set before the reading location information); Sending a short message (a fourth row; a checkbox control is set before the sending a short message); Calling a phone (a fifth row; a checkbox control is set before the calling a phone); 8 other permissions (a sixth row); and the like; a Cancel control and an Install control are set at the lowest bottom of the interface. As such, after the application program authorization permission list is loaded, the installation of the application program may be done according to the overall authorization policy of the Android platform. The difference is that, the application program authorization permission list is authorized permissions and disabled permissions preset by the user for the application program, not applied permissions in the configuration information file carried in the application program file package, such that the configured behavior permissions of the application program meet the display of the application program authorization permission list interface.

As an optional embodiment, in the subsequent flow, if the user needs to adjust the authorized permissions of the application program, the method may further comprise:

step 103: running a preset secure application program to update the authorized permissions of the application program, such that when the application program is run subsequently, it conducts corresponding access according to the updated authorized permissions.

At this step, after the user installs the corresponding application program, if he needs to update some functions of the application program or the authorized permissions granted to the application program, the user may run the secure application program, and select, on an update interface corresponding to the secure application program, behavior permissions of individual application programs that need to be disabled or authorized, to modify corresponding functions and authorized permissions of the application program, which thus supports access to the corresponding functions and authorized permissions modified by the user when the application program is run again. For example, if a certain authorized permission is disabled, the application program will not enjoy the authorized permission disabled by the user any more when it is run again.

Of course, in a practical application, it may also be that when an application program tries accessing an application program interface (API) that needs a permission, the Android platform judges whether the permission to access the API is disabled according to a record in an application program authorization permission list set by a user for the application program, and if the permission to access the API is disabled, the application program may prompt the user whether to select modification via a human-machine interface; and if the user selects to modify the permission, the Android platform allows the application program to access the API, otherwise, the Android platform notifies the application program to exit the access.

As a further optional embodiment, it may be further possible to, before installing an application program file package corresponding to an application program, perform security scanning on the application program file package to be installed, to guarantee the security of the application program file package to be installed and reduce the probability of installing a malicious application program. As such, the method further comprises:

performing security scanning on the application program file package to be installed, and if the application program file package to be installed passes the security scanning, implementing the flow of installing the application program file package, otherwise, ending the flow.

At this step, deep security scanning is performed on the application program file package before installing the application program file package. The deep security scanning comprises, but is not limited to, Trojan virus scanning, adware scanning, and vulnerability scanning. For example, for the Trojan virus scanning, it can match the application program file package with features in a pre-stored malicious program library, and when the application program file package matches a feature in the malicious program library, prompt that the application program file package is a malicious program, and suggest the user to forbid installation of the application program. Thus, before installing an application program, a malicious application program may be recognized by performing deep security scanning on the application program file package to be installed, which greatly reduces the probability of mistakenly installing a malicious application program by a user.

In the embodiments of the invention, as an optional embodiment, the application program is installed according to a class and interface of a hook provided by the intelligent terminal device operating system, that is, the application program is installed according to the existing installation flow. After the installation of the application program is completed, third-party software for installing an application program based on an intelligent terminal device provided by the embodiments of the invention causes that the existing installation interface of the application program does not display prompt information comprising completion of the installation of the application program, and triggers the loading an application program authorization permission list interface preset by a user for the application program, such that the intelligent terminal device operating system updates behavior permissions granted to the application program with respect to the intelligent terminal device operating system during the installation according to authorized behavior permissions comprised by the loaded application program authorization permission list interface, and in turn, after it is monitored that updating behavior permissions granted to the application program with respect to the intelligent terminal device operating system during the installation is completed, triggers displaying on the installation interface prompt information comprising completion of the installation of the application program.

From the above, in the method for installing an application program based on the Android platform of the embodiments of the invention, after installing an application program, a user triggers selection and determination of behavior permissions that may be granted to the application program and behavior permissions that are forbidden to be granted. Thus, for some sensitive behavior permissions, for example, permissions such as sending a short message, reading contacts, and the like, after installing the application program, by utilizing authorized behavior permissions comprised by an application program authorization permission list interface preset for the application program, the user updates behavior permissions granted to the application program with respect to the intelligent terminal device operating system during the installation, that is, the application program may be forbidden to obtain authorization of a sensitive behavior permission by the user. Therefore, even if the user accidently installs and runs a malicious application program, since corresponding behavior permissions have been disabled by the user after the installation and before the application program is run, the loss of the potential security risks may be minimized, and the security of the Android platform may be increased effectively. In particular, the embodiments of the invention have a permission management mechanism before the installation, that is, before installing an application program, a user may grant selected behavior permissions to the application program to be installed; and a permission management mechanism after the installation, that is, after the installation of the application program is completed, the user is allowed to perform permission modification on behavior permissions granted to the installed application program, and store the modified authorized permissions for conducting corresponding access by the application program according to the modified permissions when it is run.

FIG. 4 shows a structure of an apparatus for installing an application program based on an intelligent terminal device of an embodiment of the invention. With reference to FIG. 4, the apparatus comprises: a monitoring module, a loading module and a permission configuration module.

The monitoring module is configured to notify the loading module after it is monitored that an application program needs to read a configuration information file during installation of the application program.

In an embodiment of the invention, after the installation of the application program is completed, the monitoring module controls that the existing installation interface of the application program does not display prompt information comprising completion of the installation of the application program, and notifies the loading module, and after it is monitored that updating behavior permissions granted to the application program with respect to the intelligent terminal device operating system during the installation is completed, triggers displaying on the installation interface prompt information comprising completion of the installation of the application program.

As an optional embodiment, after the monitoring module monitors that an application program accesses an application program interface that needs a behavior permission, the Android platform judges whether the permission to access the application program interface is disabled according to a record in an application program authorization permission list set by a user for the application program, and if the permission to access the application program interface is disabled, prompts the user whether to select modification via a human-machine interface; and if the user selects to modify the permission, the Android platform allows the application program to access the application program interface, otherwise, the Android platform notifies the application program to exit the access.

The loading module is configured to load an application program authorization permission list interface set for the application program to be installed according to the received notification, wherein the application program authorization permission list interface is an interface for modifying an application program authorization permission list, comprises one or more behavior permission selectively authorized by a user for the application program to be installed, and records modifications to the application program authorization permission list.

The permission configuration module is configured to update the behavior permissions of the application program according to the record of the modifications to the application program authorization permission list after the installation of the application program is completed.

In an embodiment of the invention, the loading module comprises: a parsing unit, a query unit and a loading unit (not shown in the figure).

The parsing unit is configured to parse the application program file package for installing the application program, to obtain the application program identification in the application program file package.

In an embodiment of the invention, obtaining behavior permissions applied for by the application program comprises: obtaining the application program file package via the official download website of the application program; and parsing the configuration information file in the application program file package and obtaining behavior permissions that the application program needs to apply for. Therein, the parsing the configuration information file in the application program file package comprises: decompressing an application program file based on the intelligent terminal device, obtaining an encrypted configuration information file described by a global variable from the decompressed application program file, and decrypting the encrypted configuration information file to obtain a decrypted original configuration information file, and scanning the permission description portion in the decrypted original configuration information file utilizing the extensible markup language file parser in Java.

The query unit is configured to query a preset application program authorization permission list library according to the obtained application program identification, to obtain an application program authorization permission list corresponding to the application program identification.

In an embodiment of the invention, setting an application program authorization permission list library comprises: for each application program, collecting and obtaining behavior permissions applied for by the application program; and generating an application program authorization permission list stored in the application program authorization permission list library according to behavior permissions selected and authorized by a user from the obtained behavior permissions applied for by the application program. Each application program corresponds to an application program authorization permission list, and a plurality of application program authorization permission lists constitute an application program authorization permission list library.

The loading unit is configured to load the obtained application program authorization permission list on the installation interface, to generate the application program authorization permission list interface.

Preferably, the loading module may further comprise:

a first classification unit configured to classify the obtained behavior permissions applied for by the application program into privacy permissions for reminding the user to pay special attention and other permissions to be authorized directly as the application program applies for.

In a practical application, the loading module may further comprise:

a second classification unit configured to divide the privacy permissions into essential permissions essential to the running of the application program and nonessential permissions optional to the running of the application program, and display prompt information of the nonessential permissions to the user on an authorization setting interface.

As an optional embodiment, the loading module may further comprise:

a verification unit configured to perform verification of legality and rationality on the essential permissions applied for by the application program utilizing an isolation sandbox and/or static code analysis and/or automatic code feature scanning approach, to determine whether each permission in the essential permissions is an indispensable permission necessary for the application program to be run, and if not, remove the permission from the essential permissions and display it to the user as a nonessential permission.

As an optional embodiment, the loading unit comprises: a query subunit, a reconfiguration subunit and an interface generation subunit, wherein

the query subunit is configured to find out a class and interface of a hook that needs to be inserted in the configuration information file of the application program in the source code of the framework level of the running platform of the intelligent terminal device, wherein the class and interface are a class and interface involving the user privacy permissions;

the reconfiguration subunit is configured to analyze and modify the source code of the class and interface, such that the class and interface of the hook inserted when the configuration information file needs to be read are directed to the application program authorization permission list preset for the application program to be installed; and

the interface generation subunit is configured to run a preset program code segment, and load the application program authorization permission list to the current installation interface to generate the application program authorization permission list interface.

As an optional embodiment, the apparatus may further comprise:

a displaying module configured to display the obtained behavior permissions applied for by the application program.

As a further optional embodiment, the apparatus may further comprise:

a permission updating module configured to run a preset secure application program to update the authorized behavior permissions of the application program, such that when the application program is run subsequently, it conducts corresponding access according to the updated authorized behavior permissions.

As still a further optional embodiment, the apparatus may further comprise:

a security scanning module configured to perform security scanning on an application program file package to be installed, and if the application program file package to be installed passes the security scanning, implement the flow of installing the application program file package, otherwise, end the flow.

In an embodiment of the invention, the security scanning comprises, but is not limited to, Trojan virus scanning, adware scanning, and vulnerability scanning.

FIG. 2 shows another flow of a method for installing an application program based on an intelligent terminal device of an embodiment of the invention. With reference to FIG. 2, the flow comprises steps 201-202.

At the step 201, an application program is installed, and after it is monitored that the application program needs to read a configuration information file, an application program authorization permission list interface set for the application program to be installed is loaded, wherein the application program authorization permission list interface is an interface for modifying an application program authorization permission list, and comprises one or more behavior permission selectively authorized by a user for the application program to be installed.

At this step, loading an application program authorization permission list interface set for the application program to be installed comprises steps A211-A213.

At A211, the application program file package for installing the application program is parsed, to obtain the application program identification in the application program file package.

At this step, by parsing the application program file package, the application program identification for uniquely marking the application program may be obtained.

At A212, a preset application program authorization permission list library is queried according to the obtained application program identification, to obtain an application program authorization permission list corresponding to the application program identification.

At this step, in the preset application program authorization permission list library, certain application program corresponds to an application program authorization permission list, and the application program authorization permission list takes the application program identification as a mark. In each application program authorization permission list are stored behavior permissions authorized in advance by a user for the application program. If the list has no behavior permissions corresponding to the application program, then there is no specific permission suggestion, however, the user still can authorize or disable all the permissions.

In an embodiment of the invention, the preset application program authorization permission list library may be obtained by the following approach:

performing the following steps B211 and B212 for each application program.

At B211, behavior permissions applied for by the application program are collected and obtained.

At this step, permission authorization needs to be conducted for an application program in advance before the application program is installed. As an optional embodiment, an application program file package may be obtained via the official download website of the application program, or also the application program file package provided by a formal application program provider may be obtained from other approach. For example, the application program file package is obtained from an application program operator website. That is, the application program file package may be uploaded by an application program developer, or also may be uploaded by an application program operator, or also may be a legitimate copy of application program file package uploaded via other channel, as long as a legitimate copy of application program file package can be obtained. As such, by obtaining the application program file package via a formal approach, the legality and rationality of permissions applied for by the application program may be ensured, avoiding that after the application program file package is modified illegally via other approach, the illegally modified application program maliciously applies for more behavior permissions involving the user security.

After downloading and obtaining the application program file package, behavior permissions that the application program needs to apply for may be obtained by parsing the configuration information file in the application program file package.

In an embodiment of the invention, under the Android platform, the application program file package is an APK file. Each APK file comprises binary code information, resource information, a configuration information file, etc. of an application program. The configuration information file is an AndroidManifest.xml file in the APK file, must be defined and comprised by each application program, and it describes information of the name, version, permissions, referenced library files, etc. of an application program. In a practical application, parsing the configuration information file in an application program file package comprises: decompressing an application program file based on the Android platform, obtaining an encrypted configuration information file described by a global variable from the decompressed application program file, namely, an AndroidManifest.xml file, and decrypting the encrypted configuration information file to obtain a decrypted original configuration information file: an AndroidManifest.xml file; and scanning the permission description portion in the AndroidManifest.xml file, to obtain a list of behavior permissions applied for by the application program, wherein the behavior permissions comprised in the list of behavior permissions are behavior permissions applied for by the application program.

The form of the statement of the behavior permissions of the application program in the AndroidManifest.xml file is as follows:

File name: AndroidManifest.xml

<uses-permission android:name=“use permissions”/>

As an optional embodiment, in the above parsing flow, the Extensible Markup Language (XML) file parser in Java may be used to parse the permission description portion in the AndroidManifest.xml file to obtain the list of behavior permissions applied for by the application program. Of course, it may also be possible to use other XML parser, or use other programming language, for example, a programming language such as C/C++, python, etc., to develop an XML parser, to parse the AndroidManifest.xml file to obtain the list of behavior permissions applied for by the corresponding application program.

At B212, an application program authorization permission list stored in the application program authorization permission list library is generated according to authorized behavior permissions selected by a user from the obtained behavior permissions applied for by the application program.

At this step, from behavior permissions applied for by each application program, according to his own business needs and the security considerations, a user conducts permission authorization for each application program respectively, and according to authorized behavior permissions selected for each application program, generates an application program authorization permission list corresponding to the application program. Each application program corresponds to an application program authorization permission list, and the application program authorization permission list is marked with an application program identification. In an embodiment of the invention, a plurality of application program authorization permission lists constitute an application program authorization permission list library, and an application program authorization permission list not only comprises one or more behavior permission authorized by a user for an application program, but also comprises one or more behavior permission forbidden to be authorized by the user for the application program. That is, for a behavior permission in an application program authorization permission list, its attribute is authorized or forbidden to be authorized. If a behavior permission that is applied for is in the application program authorization permission list, and its attribute is authorized, the behavior permission access applied for by the application program is allowed; and if a behavior permission that is applied for is in the application program authorization permission list, and its attribute is forbidden to be authorized, the behavior permission access applied for by the application program is denied.

As an optional embodiment, in order to facilitate the authorization and selection operation performed by the user on the behavior permissions, before the user selects an authorized permission from the obtained behavior permissions applied for by the application program, the method may further comprise:

displaying the obtained behavior permissions applied for by the application program.

At this step, an authorization setting interface (the application program authorization permission list interface) is provided to the user, the behavior permissions applied for by the application program are displayed on the authorization setting interface, and the user makes authorization selection of a displayed behavior permission on the authorization setting interface. Thus, the user may conveniently select a needed behavior permission for authorization by means of the visual authorization setting interface.

As a further optional embodiment, to improve the user's understanding of the behavior permissions applied for by the application program, the method may further comprise:

classifying the obtained behavior permissions applied for by the application program.

At this step, the obtained behavior permissions can be classified into privacy permissions and other permissions for each application program, wherein, for the privacy permissions, it is necessary to remind the user to pay special attention due to involvement of the user's privacy, whereas for the other permissions, the user may, according to the application by the application program, grant the permissions to it without paying much attention.

In an embodiment of the invention, a privacy permission comprises, but is not limited to, the following information: sending a short message (android.permission.SEND_SMS), access to the internet (android.permission.INTERNET), reading a short message (android.permission.READ_SMS), writing a short message (android.permission.WRITE_SMS), reading contacts (android.permission.READ_CONTACTS), writing contacts (android.permission.WRITE_CONTACTS), calling a phone (android.permission.CALL_PHONE), writing system settings (android.permission.WRITE_SYNC_SETTINGS), reading location information, recording audio and reading audio recording information. Each privacy permission corresponds to a function. For example, for the permission to send a short message, the corresponding function is SmsManager.sendTextMessage, SmsManager.sendDataMessage, SmsManager.sendMultipartTextMessage, etc.

For the privacy permissions, they may be further divided into essential permissions and nonessential permissions. Therein, an essential permission is a behavior permission that is essential to the running of an application program and authorized by a user. If the authorized behavior permission is lacked, the application program can not be run normally. If the user needs to install the application program, he must authorize all the essential permissions applied for by the application program, otherwise, the installation can not be done. A nonessential permission is a behavior permission that is needed by an application program and authorized by a user, however, it is optional and will not affect the running of the application program. If the behavior permission is not authorized by the user, this will not affect the installation and running of the application program. For example, the essential permissions may comprise: writing contacts, calling a phone, and the like, and the nonessential permissions may comprise: reading location information, access to the internet, reading audio recording information, and the like.

As an optional embodiment, for a nonessential permission, prompt information of the nonessential permission is further displayed to the user on the authorization setting interface. The prompt information may be: a nonessential permission, recommend to cancel, or the permission is an optionally authorized item, authorize it according to your own security policy, or the like. That is, the user is suggested to carefully select a behavior permission granted to an application program based on his own privacy security considerations when authorizing nonessential permissions.

As a further optional embodiment, for essential permissions, verification can be further performed to determine whether all the essential permissions are essential to the running of an application program, that is, verification of legality and rationality is performed on the essential permissions applied for by the application program. An approach for verification may be utilizing an isolation sandbox and/or static code analysis and/or automatic code feature scanning, etc., to determine whether each behavior permission in the essential permissions is an indispensable behavior permission necessary for the application program to be run, and if not, the behavior permission is removed from the essential permissions and displayed to the user as a nonessential permission. Therein, by applying the static code analysis, the security risks and vulnerabilities existing in the essential permissions applied for by each application program can be found and located rapidly and accurately. And, by using the virtual machine technology, the isolation sandbox clones a certain partition or all partitions of a hard disk in the Android platform via a virtual machine, and forms a shadow, which is called a shadow mode. The shadow mode has the same architecture and functions as the Android platform system, and a user may run an application program in the shadow mode. Any operation of an application program, for example, deleting & modifying a file, installing & testing various application programs (including rogue application programs, virus application programs), is wrapped by the isolation sandbox, interception of user privacy information by a malicious application program is restricted within the isolation sandbox, and as soon as the isolation sandbox is closed, operations that endanger the Android platform can be erased. Therefore, by monitoring behaviors of accessing user data by an application program via the isolation sandbox approach, it may be determined whether the essential permissions applied for by the application program involve permission abuse, that is, whether the application program has applied to the user for a behavior permission that should not be applied for for various purposes. If the application program has applied for an additional behavior permission by way of an essential permission, which may lead to leakage of the user privacy information, the behavior permission that has been applied for additionally needs to be removed from the essential permissions. For example, if a stand-alone game application program has applied for a behavior permission to read a user's phone book, the reading a user's phone book might belong to a behavior permission that the stand-alone game application program should not applied for, which thus enhances the security of the user privacy. Utilizing an approach of isolation sandbox, static code analysis, and automatic code feature scanning, etc. to perform verification of legality and rationality on essential permissions applied for by an application program is a well-known technique, of which a detailed description will be omitted here.

As such, by classifying behavior permissions applied for by an application program into privacy permissions and other permissions, such that a user pays attention to a privacy permission involved therein, and thereby considers whether he needs to grant the permission to the application program, the user privacy security is guaranteed; further, by dividing the privacy permissions into essential permissions and nonessential permissions, such that for a nonessential permission, a user tries to avoid its authorization based on his own security policy, the user privacy security is thus improved; and moreover, for an essential permission, its verification of legality and rationality may remove behavior permissions additionally applied for by a malicious application program, the user security is guaranteed to the greatest extent.

At A213, the obtained application program authorization permission list is loaded on the installation interface, to generate the application program authorization permission list interface.

At this step, the loaded application program authorization permission list interface is employed to replace the installation interface of the application program provided by the intelligent terminal device operating system during its installation. Loading an application program authorization permission list interface set for the application program to be installed comprises: jumping and directing the installation interface provided by the intelligent terminal device operating system to the application program authorization permission list interface via a hook, and ending the jumping of the installation interface provided by the intelligent terminal device operating system after confirming or completing modification to the application program authorization permission list. In particular, it can find out a class and interface of a hook that needs to be inserted in the installation implementation of the application program in the source code of the framework level of the Android platform, wherein such a class and interface are a class and interface involving the user privacy information. By analyzing and modifying the source code of the class and interface, the class and interface of the hook inserted when the configuration information file needs to be read are made to be directed to the application program authorization permission list preset by the embodiment of the invention, not to the configuration information file in the application program file package. A preset program code segment is run, the application program authorization permission list is loaded to the current installation interface to generate the application program authorization permission list interface, and after completion of the application program authorization permission list interface, operations after reading the configuration information file of the application program are directed to, such that the operations after completion of the application program authorization permission list interface are the same as the existing operations after reading the configuration information file of the application program. That is, in an interface after behavior permissions of the application program are configured according to authorized behavior permissions comprised in the loaded application program authorization permission list interface, the direction of the class and interface of the hook that the Next control needs to correspondingly insert is set, wherein the direction is the same as that of the class and interface of the inserted hook that the Next control needs to correspondingly insert displayed after the application program reads the configuration information file to perform behavior permission configuration of the application program. The implementation of modification to the source code according to the functions described by the embodiment of the invention is a well-known technique, of which the detailed description will be omitted here. In a practical application, the original default application program installer of the Android platform is replaced by way of modifying the source code, thereby implementing the loading of the application program authorization permission list of the embodiment of the invention, wherein an approach of replacing the original installer of the Android platform comprises, but is not limited to, the following: selecting by a user a new installer as the default installer of the Android platform, directly replacing the original application program installation solution of the Android platform on a Rooted mobile terminal, and replacing the original application program installation solution of the Android platform in the ROM of a mobile terminal.

At the step 202, behavior permissions of the application program are configured according to the authorized behavior permissions comprised in the loaded application program authorization permission list interface, and the installation of the application program is completed.

At this step, after the application program installer configures the behavior permissions of the application program according to the loaded application program authorization permission list, the subsequent installation flow is a well-known technique, of which the detailed description will be omitted here.

In an embodiment of the invention, during the installation of the application program, for example, the application program authorization permission list interface displayed to the user may be displayed in rows, and each of the rows is in particular sequentially as follows: This application program has applied for 11 permissions, and whether install this application program? (a first row); 3 privacy permissions (nonessential permissions, recommend to cancel) (a second row); Reading location information (a third row; a checkbox control is set before the reading location information); Sending a short message (a fourth row; a checkbox control is set before the sending a short message); Calling a phone (a fifth row; a checkbox control is set before the calling a phone); 8 other permissions (a sixth row); and the like; a Cancel control and an Install control are set at the lowest bottom of the interface. As such, after the application program authorization permission list is loaded, the installation of the application program may be done according to the overall authorization policy of the Android platform. The difference is that, the application program authorization permission list is authorized permissions and disabled permissions preset by the user for the application program, not applied permissions in the configuration information file carried in the application program file package, such that the configured behavior permissions of the application program meet the display of the application program authorization permission list interface.

As an optional embodiment, in the subsequent flow, if the user needs to adjust the authorized permissions of the application program, the method may further comprise: step 203: running a preset secure application program to update the authorized permissions of the application program, such that when the application program is run subsequently, it conducts corresponding access according to the updated authorized permissions.

At this step, after the user installs the corresponding application program, if he needs to update some functions of the application program or the authorized permissions granted to the application program, the user may run the secure application program, and select, on an update interface corresponding to the secure application program, behavior permissions of individual application programs that need to be disabled or authorized, to modify corresponding functions and authorized permissions of the application program, which thus supports access to the corresponding functions and authorized permissions modified by the user when the application program is run again. For example, if a certain authorized permission is disabled, the application program will not enjoy the authorized permission disabled by the user any more when it is run again.

Of course, in a practical application, it may also be that when an application program tries accessing an application program interface (API) that needs a permission, the Android platform judges whether the permission to access the API is disabled according to a record in an application program authorization permission list set by a user for the application program, and if the permission to access the API is disabled, the application program may prompt the user whether to select modification via a human-machine interface; and if the user selects to modify the permission, the Android platform allows the application program to access the API, otherwise, the Android platform notifies the application program to exit the access.

As a further optional embodiment, it may be further possible to, before installing an application program file package, perform security scanning on the application program file package to be installed, to guarantee the security of the application program file package to be installed and reduce the probability of installing a malicious application program. As such, the method further comprises:

performing security scanning on the application program file package to be installed, and if the application program file package to be installed passes the security scanning, implementing the flow of installing the application program file package, otherwise, ending the flow.

At this step, deep security scanning is performed on the application program file package before installing the application program file package. The deep security scanning comprises, but is not limited to, Trojan virus scanning, adware scanning, and vulnerability scanning. For example, for the Trojan virus scanning, it can match the application program file package with features in a pre-stored malicious program library, and when the application program file package matches a feature in the malicious program library, prompt that the application program file package is a malicious program, and suggest the user to forbid installation of the application program. Thus, before installing an application program, a malicious application program may be recognized by performing deep security scanning on the application program file package to be installed, which greatly reduces the probability of mistakenly installing a malicious application program by a user.

From the above, in the method for installing an application program based on the Android platform of the embodiments of the invention, before installing an application program, a user may select and determine behavior permissions that may be granted to the application program and behavior permissions that are forbidden to be granted. Thus, for some sensitive behavior permissions, for example, permissions such as sending a short message, reading contacts, and the like, before installing the application program, the user may forbid the application program to obtain authorization of a sensitive behavior permission by the user, and during the installation of the application program, permissions of the application program are configured employing the authorized permissions selected and determined before the user installs the application program. Therefore, even if the user accidently installs and runs a malicious application program, since corresponding behavior permissions have been disabled by the user before the installation, the loss of the potential security risks may be minimized, and the security of the Android platform may be increased effectively. In particular, the embodiments of the invention have a permission management mechanism before the installation, that is, before installing an application program, a user may grant selected behavior permissions to the application program to be installed; and a permission management mechanism after the installation, that is, after the installation of the application program is completed, the user is allowed to perform permission modification on behavior permissions granted to the installed application program, and store the modified authorized permissions for conducting corresponding access by the application program according to the modified permissions when it is run.

FIG. 4 shows a structure of an apparatus for installing an application program based on an intelligent terminal device of an embodiment of the invention. With reference to FIG. 4, the apparatus comprises: a monitoring module, a loading module and a permission configuration module.

The monitoring module is configured to install an application program and notify the loading module after it is monitored that the application program needs to read a configuration information file.

In an embodiment of the invention, after the monitoring module monitors that an application program accesses an application program interface that needs a behavior permission, the Android platform judges whether the permission to access the application program interface is disabled according to a record in an application program authorization permission list set by a user for the application program, and if the permission to access the application program interface is disabled, prompts the user whether to select modification via a human-machine interface; and if the user selects to modify the permission, the Android platform allows the application program to access the application program interface, otherwise, the Android platform notifies the application program to exit the access.

The loading module is configured to load an application program authorization permission list interface set for the application program to be installed according to the received notification, wherein the application program authorization permission list interface is an interface for modifying an application program authorization permission list, and comprises one or more behavior permission selectively authorized by a user for the application program to be installed.

The permission configuration module is configured to configure the behavior permissions of the application program according to authorized behavior permissions comprised in the loaded application program authorization permission list interface, and complete the installation of the application program.

In an embodiment of the invention, the loading module comprises: a parsing unit, a query unit and a loading unit (not shown in the figure).

The parsing unit is configured to parse the application program file package for installing the application program, to obtain the application program identification in the application program file package.

In an embodiment of the invention, obtaining behavior permissions applied for by the application program comprises: obtaining the application program file package via the official download website of the application program; and parsing the configuration information file in the application program file package and obtaining behavior permissions that the application program needs to apply for. Therein, the parsing the configuration information file in the application program file package comprises: decompressing an application program file based on the intelligent terminal device, obtaining an encrypted configuration information file described by a global variable from the decompressed application program file, and decrypting the encrypted configuration information file to obtain a decrypted original configuration information file, and scanning the permission description portion in the decrypted original configuration information file utilizing the extensible markup language file parser in Java.

The query unit is configured to query a preset application program authorization permission list library according to the obtained application program identification, to obtain an application program authorization permission list corresponding to the application program identification.

In an embodiment of the invention, setting an application program authorization permission list library comprises: for each application program, collecting and obtaining behavior permissions applied for by the application program; and generating an application program authorization permission list stored in the application program authorization permission list library according to behavior permissions selected and authorized by a user from the obtained behavior permissions applied for by the application program. Each application program corresponds to an application program authorization permission list, and a plurality of application program authorization permission lists constitute an application program authorization permission list library.

The loading unit is configured to load the obtained application program authorization permission list on the installation interface, to generate the application program authorization permission list interface.

Preferably, the loading module may further comprise:

a first classification unit configured to classify the obtained behavior permissions applied for by the application program into privacy permissions for reminding the user to pay special attention and other permissions to be authorized directly as the application program applies for.

In a practical application, the loading module may further comprise:

a second classification unit configured to divide the privacy permissions into essential permissions essential to the running of the application program and nonessential permissions optional to the running of the application program, and display prompt information of the nonessential permissions to the user on an authorization setting interface.

As an optional embodiment, the loading module may further comprise:

a verification unit configured to perform verification of legality and rationality on the essential permissions applied for by the application program utilizing an isolation sandbox and/or static code analysis and/or automatic code feature scanning approach, to determine whether each permission in the essential permissions is an indispensable permission necessary for the application program to be run, and if not, remove the permission from the essential permissions and display it to the user as a nonessential permission.

As an optional embodiment, the loading unit comprises: a query subunit, a reconfiguration subunit and an interface generation subunit, wherein

the query subunit is configured to find out a class and interface of a hook that needs to be inserted in the configuration information file of the application program in the source code of the framework level of the running platform of the intelligent terminal device, wherein the class and interface are a class and interface involving the user privacy permissions;

the reconfiguration subunit is configured to analyze and modify the source code of the class and interface, such that the class and interface of the hook inserted when the configuration information file needs to be read are directed to the application program authorization permission list preset for the application program to be installed; and

the interface generation subunit is configured to run a preset program code segment, and load the application program authorization permission list to the current installation interface to generate the application program authorization permission list interface.

As an optional embodiment, the apparatus may further comprise:

a displaying module configured to display the obtained behavior permissions applied for by the application program.

As a further optional embodiment, the apparatus may further comprise:

a permission updating module configured to run a preset secure application program to update the authorized behavior permissions of the application program, such that when the application program is run subsequently, it conducts corresponding access according to the updated authorized behavior permissions.

As still a further optional embodiment, the apparatus may further comprise:

a security scanning module configured to perform security scanning on an application program file package to be installed, and if the application program file package to be installed passes the security scanning, implement the flow of installing the application program file package, otherwise, end the flow.

In an embodiment of the invention, the security scanning comprises, but is not limited to, Trojan virus scanning, adware scanning, and vulnerability scanning.

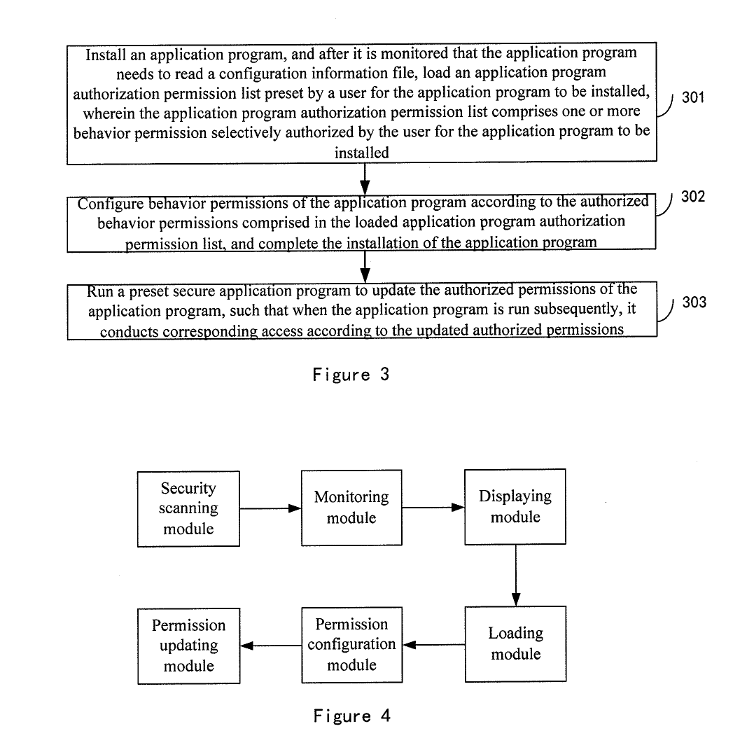

FIG. 3 shows still another flow of a method for installing an application program based on an intelligent terminal device of an embodiment of the invention. With reference to FIG. 3, the flow comprises steps 301-302.

At the step 301, an application program is installed, and after it is monitored that the application program needs to read a configuration information file, an application program authorization permission list preset by a user for the application program to be installed is loaded, wherein the application program authorization permission list comprises one or more behavior permission selectively authorized by the user for the application program to be installed.

At this step, loading an application program authorization permission list preset by a user for the application program to be installed comprises steps A311-A313.

At A311, the application program file package for installing the application program is parsed, to obtain the application program identification in the application program file package.

At this step, by parsing the application program file package, the application program identification for uniquely marking the application program may be obtained.

At A312, a preset application program authorization permission list library is queried according to the obtained application program identification, to obtain an application program authorization permission list corresponding to the application program identification.

At this step, in the preset application program authorization permission list library, certain application program corresponds to an application program authorization permission list, and the application program authorization permission list takes the application program identification as a mark. In each application program authorization permission list are stored behavior permissions authorized in advance by a user for the application program. If the list has no behavior permissions corresponding to the application program, then there is no specific permission suggestion, however, the user still can authorize or disable all the permissions.

In an embodiment of the invention, the preset application program authorization permission list library may be obtained by the following approach:

performing the following steps B311 and B312 for each application program.

At B311, during installation of the application program, after it is monitored that the application program reads a configuration information file, behavior permissions applied for by the application program with respect to the intelligent terminal device operating system in the configuration information file are collected and obtained.

At this step, permission authorization needs to be conducted for an application program in advance before the application program is installed. As an optional embodiment, an application program file package may be obtained via the official download website of the application program, or also the application program file package provided by a formal application program provider may be obtained from other approach. For example, the application program file package is obtained from an application program operator website. That is, the application program file package may be uploaded by an application program developer, or also may be uploaded by an application program operator, or also may be a legitimate copy of application program file package uploaded via other channel, as long as a legitimate copy of application program file package can be obtained. As such, by obtaining the application program file package via a formal approach, the legality and rationality of permissions applied for by the application program may be ensured, avoiding that after the application program file package is modified illegally via other approach, the illegally modified application program maliciously applies for more behavior permissions involving the user security.

After downloading and obtaining the application program file package, behavior permissions that the application program needs to apply for may be obtained by parsing the configuration information file in the application program file package.

In an embodiment of the invention, under the Android platform, the application program file package is an APK file. Each APK file comprises binary code information, resource information, a configuration information file, etc. of an application program. The configuration information file is an AndroidManifest.xml file in the APK file, must be defined and comprised by each application program, and it describes information of the name, version, permissions, referenced library files, etc. of an application program. In a practical application, parsing the configuration information file in an application program file package comprises: decompressing an application program file based on the Android platform, obtaining an encrypted configuration information file described by a global variable from the decompressed application program file, namely, an AndroidManifest.xml file, and decrypting the encrypted configuration information file to obtain a decrypted original configuration information file: an AndroidManifest.xml file; and scanning the permission description portion in the AndroidManifest.xml file, to obtain a list of behavior permissions applied for by the application program, wherein the behavior permissions comprised in the list of behavior permissions are behavior permissions applied for by the application program.

The form of the statement of the behavior permissions of the application program in the AndroidManifest.xml file is as follows:

File name: AndroidManifest.xml

<uses-permission android:name=“use permissions”/>

As an optional embodiment, in the above parsing flow, the Extensible Markup Language (XML) file parser in Java may be used to parse the permission description portion in the AndroidManifest.xml file to obtain the list of behavior permissions applied for by the application program. Of course, it may also be possible to use other XML parser, or use other programming language, for example, a programming language such as C/C++, python, etc., to develop an XML parser, to parse the AndroidManifest.xml file to obtain the list of behavior permissions applied for by the corresponding application program.

At B312, an application program authorization permission list stored in the application program authorization permission list library is generated according to authorized behavior permissions selected by a user from the obtained behavior permissions applied for by the application program.

At this step, from behavior permissions applied for by each application program, according to his own business needs and the security considerations, a user conducts permission authorization for each application program respectively, and according to authorized behavior permissions selected for each application program, generates an application program authorization permission list corresponding to the application program. Each application program corresponds to an application program authorization permission list, and the application program authorization permission list is marked with an application program identification. In an embodiment of the invention, a plurality of application program authorization permission lists constitute an application program authorization permission list library, and an application program authorization permission list not only comprises one or more behavior permission authorized by a user for an application program, but also comprises one or more behavior permission forbidden to be authorized by the user for the application program. That is, for a behavior permission in an application program authorization permission list, its attribute is authorized or forbidden to be authorized. If a behavior permission that is applied for is in the application program authorization permission list, and its attribute is authorized, the behavior permission access applied for by the application program is allowed; and if a behavior permission that is applied for is in the application program authorization permission list, and its attribute is forbidden to be authorized, the behavior permission access applied for by the application program is denied.

As an optional embodiment, in order to facilitate the authorization and selection operation performed by the user on the behavior permissions, before the user selects an authorized permission from the obtained behavior permissions applied for by the application program, the method may further comprise:

displaying the obtained behavior permissions applied for by the application program.

At this step, an authorization setting interface is provided to the user, the behavior permissions applied for by the application program are displayed on the authorization setting interface, and the user makes authorization selection of a displayed behavior permission on the authorization setting interface. Thus, the user may conveniently select a needed behavior permission for authorization by means of the visual authorization setting interface.

As a further optional embodiment, to improve the user's understanding of the behavior permissions applied for by the application program, the method may further comprise:

classifying the obtained behavior permissions applied for by the application program.

At this step, the obtained behavior permissions can be classified into privacy permissions and other permissions for each application program, wherein, for the privacy permissions, it is necessary to remind the user to pay special attention to involvement of the user's privacy, whereas for the other permissions, the user may, according to the application by the application program, grant the permissions to it without paying much attention.

In an embodiment of the invention, a privacy permission comprises, but is not limited to, the following information: sending a short message (android.permission.SEND_SMS), access to the internet (android.permission.INTERNET), reading a short message (android.permission.READ_SMS), writing a short message (android.permission.WRITE_SMS), reading contacts (android.permission.READ_CONTACTS), writing contacts (android.permission.WRITE_CONTACTS), calling a phone (android.permission.CALL PHONE), writing system settings (android.permission.WRITE_SYNC_SETTINGS), reading location information, recording audio and reading audio recording information. Each privacy permission corresponds to a function. For example, for the permission to send a short message, the corresponding function is SmsManager.sendTextMessage, SmsManager.sendDataMessage, SmsManager.sendMultipartTextMessage, etc.

For the privacy permissions, they may be further divided into essential permissions and nonessential permissions. Therein, an essential permission is a behavior permission that is essential to the running of an application program and authorized by a user. If the authorized behavior permission is lacked, the application program can not be run normally. If the user needs to install the application program, he must authorize all the essential permissions applied for by the application program, otherwise, the installation can not be done. A nonessential permission is a behavior permission that is needed by an application program and authorized by a user, however, it is optional and will not affect the running of the application program. If the behavior permission is not authorized by the user, this will not affect the installation and running of the application program. For example, the essential permissions may comprise: writing contacts, calling a phone, and the like, and the nonessential permissions may comprise: reading location information, access to the interne, reading audio recording information, and the like.

As an optional embodiment, for a nonessential permission, prompt information of the nonessential permission is further displayed to the user on the authorization setting interface. The prompt information may be: a nonessential permission, recommend to cancel, or the permission is an optionally authorized item, authorize it according to your own security policy, or the like. That is, the user is suggested to carefully select a behavior permission granted to an application program based on his own privacy security considerations when authorizing nonessential permissions.

As a further optional embodiment, for essential permissions, verification can be further performed to determine whether all the essential permissions are essential to the running of an application program, that is, verification of legality and rationality is performed on the essential permissions applied for by the application program. An approach for verification may be utilizing an isolation sandbox and/or static code analysis and/or automatic code feature scanning, etc., to determine whether each behavior permission in the essential permissions is an indispensable behavior permission necessary for the application program to be run, and if not, the behavior permission is removed from the essential permissions and displayed to the user as a nonessential permission. Therein, by applying the static code analysis, the security risks and vulnerabilities existing in the essential permissions applied for by each application program can be found and located rapidly and accurately. And, by using the virtual machine technology, the isolation sandbox clones a certain partition or all partitions of a hard disk in the Android platform via a virtual machine, and forms a shadow, which is called a shadow mode. The shadow mode has the same architecture and functions as the Android platform system, and a user may run an application program in the shadow mode. Any operation of an application program, for example, deleting & modifying a file, installing & testing various application programs (including rogue application programs, virus application programs), is wrapped by the isolation sandbox, interception of user privacy information by a malicious application program is restricted within the isolation sandbox, and as soon as the isolation sandbox is closed, operations that endanger the Android platform can be erased. Therefore, by monitoring behaviors of accessing user data by an application program via the isolation sandbox approach, it may be determined whether the essential permissions applied for by the application program involve permission abuse, that is, whether the application program has applied to the user for a behavior permission that should not be applied for for various purposes. If the application program has applied for an additional behavior permission by way of an essential permission, which may lead to leakage of the user privacy information, the behavior permission that has been applied for additionally needs to be removed from the essential permissions. For example, if a stand-alone game application program has applied for a behavior permission to read a user's phone book, the reading a user's phone book might belong to a behavior permission that the stand-alone game application program should not applied for, which thus enhances the security of the user privacy. Utilizing an approach of isolation sandbox, static code analysis, and automatic code feature scanning, etc. to perform verification of legality and rationality on essential permissions applied for by an application program is a well-known technique, of which a detailed description will be omitted here.

As such, by classifying behavior permissions applied for by an application program into privacy permissions and other permissions, such that a user pays attention to a privacy permission involved therein, and thereby considers whether he needs to grant the permission to the application program, the user privacy security is guaranteed; further, by dividing the privacy permissions into essential permissions and nonessential permissions, such that for a nonessential permission, a user tries to avoid its authorization based on his own security policy, the user privacy security is thus improved; and moreover, for an essential permission, its verification of legality and rationality may remove behavior permissions additionally applied for by a malicious application program, the user security is guaranteed to the greatest extent.

At A313, the obtained application program authorization permission list is loaded on the installation interface.

At this step, the intelligent terminal device operating system is an Android system. Loading an application program authorization permission list preset by a user for the application program to be installed comprises: jumping and directing the installation interface provided by the intelligent terminal device operating system to an interface corresponding to the application program authorization permission list via a hook, and ending the jumping of the installation interface provided by the intelligent terminal device operating system after confirming or completing modification to the application program authorization permission list. In particular, it can find out a class and interface of a hook that needs to be inserted in the installation implementation of the application program in the source code of the framework level of the Android platform, wherein such a class and interface are a class and interface involving the user privacy information. By analyzing and modifying the source code of the class and interface, the class and interface of the hook inserted when the configuration information file needs to be read are made to be directed to the application program authorization permission list preset by the embodiment of the invention, not to the configuration information file in the application program file package. A preset program code segment is run, the application program authorization permission list is loaded to the current installation interface, and after completion of being loaded to the current installation interface, operations after reading the configuration information file of the application program are directed to, such that the operations after completion of the application program authorization permission list are the same as the existing operations after reading the configuration information file of the application program. That is, in an interface after behavior permissions of the application program are configured according to authorized behavior permissions comprised in the loaded application program authorization permission list, the direction of the class and interface of the hook that the Next control needs to correspondingly insert to is set, wherein the direction is the same as that of the class and interface of the hook that the Next control needs to correspondingly insert displayed after the application program reads the configuration information file to perform behavior permission configuration of the application program. The implementation of modification to the source code according to the functions described by the embodiment of the invention is a well-known technique, of which the detailed description will be omitted here. In a practical application, the original default application program installer of the Android platform is replaced by way of modifying the source code, thereby implementing the loading of the application program authorization permission list of the embodiment of the invention, wherein an approach of replacing the original installer of the Android platform comprises, but is not limited to, the following: selecting by a user a new installer as the default installer of the Android platform, directly replacing the original application program installation solution of the Android platform on a Rooted mobile terminal, and replacing the original application program installation solution of the Android platform in the ROM of a mobile terminal.

At the step 302, behavior permissions of the application program are configured according to the authorized behavior permissions comprised in the loaded application program authorization permission list, and the installation of the application program is completed.

At this step, after the application program installer configures the behavior permissions of the application program according to the loaded application program authorization permission list, the subsequent installation flow is a well-known technique, of which the detailed description will be omitted here.

In an embodiment of the invention, during the installation of the application program, for example, the interface corresponding to the application program authorization permission list displayed to the user may be displayed in rows, and each of the rows is in particular sequentially as follows: This application program has applied for 11 permissions, and whether install this application program? (a first row); 3 privacy permissions (nonessential permissions, recommend to cancel) (a second row); Reading location information (a third row; a checkbox control is set before the reading location information); Sending a short message (a fourth row; a checkbox control is set before the sending a short message); Calling a phone (a fifth row; a checkbox control is set before the calling a phone); 8 other permissions (a sixth row); and the like; a Cancel control and an Install control are set at the lowest bottom of the interface. As such, after the application program authorization permission list is loaded, the installation of the application program may be done according to the overall authorization policy of the Android platform. The difference is that, the application program authorization permission list is authorized permissions and disabled permissions preset by the user for the application program, not applied permissions in the configuration information file carried in the application program file package, such that the configured behavior permissions of the application program meet the application program authorization permission list.

As an optional embodiment, in the subsequent flow, if the user needs to adjust the authorized permissions of the application program, the method may further comprise:

step 303: running a preset secure application program to update the authorized permissions of the application program, such that when the application program is run subsequently, it conducts corresponding access according to the updated authorized permissions.

At this step, after the user installs the corresponding application program, if he needs to update some functions of the application program or the authorized permissions granted to the application program, the user may run the secure application program, and select, on an update interface corresponding to the secure application program, behavior permissions of individual application programs that need to be disabled or authorized, to modify corresponding functions and authorized permissions of the application program, which thus supports access to the corresponding functions and authorized permissions modified by the user when the application program is run again. For example, if a certain authorized permission is disabled, the application program will not enjoy the authorized permission disabled by the user any more when it is run again.

Of course, in a practical application, it may also be that when an application program tries accessing an application program interface (API) that needs a permission, the Android platform judges whether the permission to access the API is disabled according to a record in an application program authorization permission list set by a user for the application program, and if the permission to access the API is disabled, the application program may prompt the user whether to select modification via a human-machine interface; and if the user selects to modify the permission, the Android platform allows the application program to access the API, otherwise, the Android platform notifies the application program to exit the access.

As a further optional embodiment, it may be further possible to, before installing an application program file package, perform security scanning on the application program file package to be installed, to guarantee the security of the application program file package to be installed and reduce the probability of installing a malicious application program. As such, the method further comprises:

performing security scanning on the application program file package to be installed corresponding to an application program, and if the application program file package to be installed passes the security scanning, implementing the flow of installing the application program file package, otherwise, ending the flow.

At this step, deep security scanning is performed on the application program file package before installing the application program file package. The deep security scanning comprises, but is not limited to, Trojan virus scanning, adware scanning, and vulnerability scanning. For example, for the Trojan virus scanning, it can match the application program file package with features in a pre-stored malicious program library, and when the application program file package matches a feature in the malicious program library, prompt that the application program file package is a malicious program, and suggest the user to forbid installation of the application program. Thus, before installing an application program, a malicious application program may be recognized by performing deep security scanning on the application program file package to be installed, which greatly reduces the probability of mistakenly installing a malicious application program by a user.

From the above, in the method for installing an application program based on the Android platform of the embodiments of the invention, before installing an application program, a user may select and determine behavior permissions that may be granted to the application program and behavior permissions that are forbidden to be granted. Thus, for some sensitive behavior permissions, for example, permissions such as sending a short message, reading contacts, and the like, before installing the application program, the user may forbid the application program to obtain authorization of a sensitive behavior permission by the user, and during the installation of the application program, permissions of the application program are configured employing the authorized permissions selected and determined before the user installs the application program. Therefore, even if the user accidently installs and runs a malicious application program, since corresponding behavior permissions have been disabled by the user before the installation, the loss of the potential security risks may be minimized, and the security of the Android platform may be increased effectively. In particular, the embodiments of the invention have a permission management mechanism before the installation, that is, before installing an application program, a user may grant selected behavior permissions to the application program to be installed; and a permission management mechanism after the installation, that is, after the installation of the application program is completed, the user is allowed to perform permission modification on behavior permissions granted to the installed application program, and store the modified authorized permissions for conducting corresponding access by the application program according to the modified permissions when it is run.

FIG. 4 shows a structure of an apparatus for installing an application program based on an intelligent terminal device of an embodiment of the invention. With reference to FIG. 4, the apparatus comprises: a monitoring module, a loading module and a permission configuration module.

The monitoring module is configured to install an application program and notify the loading module after it is monitored that the application program needs to read a configuration information file.

In an embodiment of the invention, after the monitoring module monitors that an application program accesses an application program interface that needs a behavior permission, the Android platform judges whether the permission to access the application program interface is disabled according to a record in an application program authorization permission list set by a user for the application program, and if the permission to access the application program interface is disabled, prompts the user whether to select modification via a human-machine interface; and if the user selects to modify the permission, the Android platform allows the application program to access the application program interface, otherwise, the Android platform notifies the application program to exit the access.

The loading module is configured to load an application program authorization permission list preset by a user for the application program to be installed according to the received notification, wherein the application program authorization permission list comprises one or more behavior permission selectively authorized by the user for the application program to be installed.

The permission configuration module is configured to configure the behavior permissions of the application program according to authorized behavior permissions comprised in the loaded application program authorization permission list and complete the installation of the application program.

In an embodiment of the invention, the loading module comprises: a parsing unit, a query unit and a loading unit (not shown in the figure).

The parsing unit is configured to parse the application program file package for installing the application program, to obtain the application program identification in the application program file package.

In an embodiment of the invention, obtaining behavior permissions applied for by the application program comprises: obtaining the application program file package via the official download website of the application program; and parsing the configuration information file in the application program file package and obtaining behavior permissions that the application program needs to apply for. Therein, the parsing the configuration information file in the application program file package comprises: decompressing an application program file based on the intelligent terminal device, obtaining an encrypted configuration information file described by a global variable from the decompressed application program file, and decrypting the encrypted configuration information file to obtain a decrypted original configuration information file, and scanning the permission description portion in the decrypted original configuration information file utilizing the extensible markup language file parser in Java.

The query unit is configured to query a preset application program authorization permission list library according to the obtained application program identification, to obtain an application program authorization permission list corresponding to the application program identification.

In an embodiment of the invention, setting an application program authorization permission list library comprises: for each application program, collecting and obtaining behavior permissions applied for by the application program; and generating an application program authorization permission list stored in the application program authorization permission list library according to behavior permissions selected and authorized by a user from the obtained behavior permissions applied for by the application program. Each application program corresponds to an application program authorization permission list, and a plurality of application program authorization permission lists constitute an application program authorization permission list library.

The loading unit is configured to load the obtained application program authorization permission list on the installation interface.

Preferably, the loading module may further comprise:

a first classification unit configured to classify the obtained behavior permissions applied for by the application program into privacy permissions for reminding the user to pay special attention and other permissions to be authorized directly as the application program applies for.

In a practical application, the loading module may further comprise:

a second classification unit configured to divide the privacy permissions into essential permissions essential to the running of the application program and nonessential permissions optional to the running of the application program, and display prompt information of the nonessential permissions to the user on an authorization setting interface.

As an optional embodiment, the loading module may further comprise:

a verification unit configured to perform verification of legality and rationality on the essential permissions applied for by the application program utilizing an isolation sandbox and/or static code analysis and/or automatic code feature scanning approach, to determine whether each permission in the essential permissions is an indispensable permission necessary for the application program to be run, and if not, remove the permission from the essential permissions and display it to the user as a nonessential permission.

As an optional embodiment, the loading unit comprises: a query subunit, a reconfiguration subunit and an interface generation subunit, wherein

the query subunit is configured to find out a class and interface of a hook that needs to be inserted in the configuration information file of the application program in the source code of the framework level of the running platform of the intelligent terminal device, wherein the class and interface are a class and interface involving the user privacy permissions;

the reconfiguration subunit is configured to analyze and modify the source code of the class and interface, such that the class and interface of the hook inserted when the configuration information file needs to be read are directed to the application program authorization permission list preset for the application program to be installed; and

the interface generation subunit is configured to run a preset program code segment, and load the application program authorization permission list to the current installation interface.

As an optional embodiment, the apparatus may further comprise:

a displaying module configured to display the obtained behavior permissions applied for by the application program.

As a further optional embodiment, the apparatus may further comprise:

a permission updating module configured to run a preset secure application program to update the authorized behavior permissions of the application program, such that when the application program is run subsequently, it conducts corresponding access according to the updated authorized behavior permissions.

As still a further optional embodiment, the apparatus may further comprise:

a security scanning module configured to perform security scanning on an application program file package to be installed corresponding to an application program, and if the application program file package to be installed passes the security scanning, implement the flow of installing the application program file package, otherwise, end the flow.

In an embodiment of the invention, the security scanning comprises, but is not limited to, Trojan virus scanning, adware scanning, and vulnerability scanning.

The algorithms and displays provided here are not inherently related to any specific computer, virtual system or other device. Various general-purpose systems may also be used with the teachings herein. According to the above description, the structure required for constructing such systems is obvious. In addition, the invention is not directed to any specific programming language. It should be understood that the content of the invention described herein may be carried out utilizing various programming languages, and that the above description for a specific language is for the sake of disclosing preferred embodiments of the invention.

In the specification provided herein, a plenty of particular details are described. However, it can be appreciated that embodiments of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in an apparatus for installing an application program based on an intelligent terminal device according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

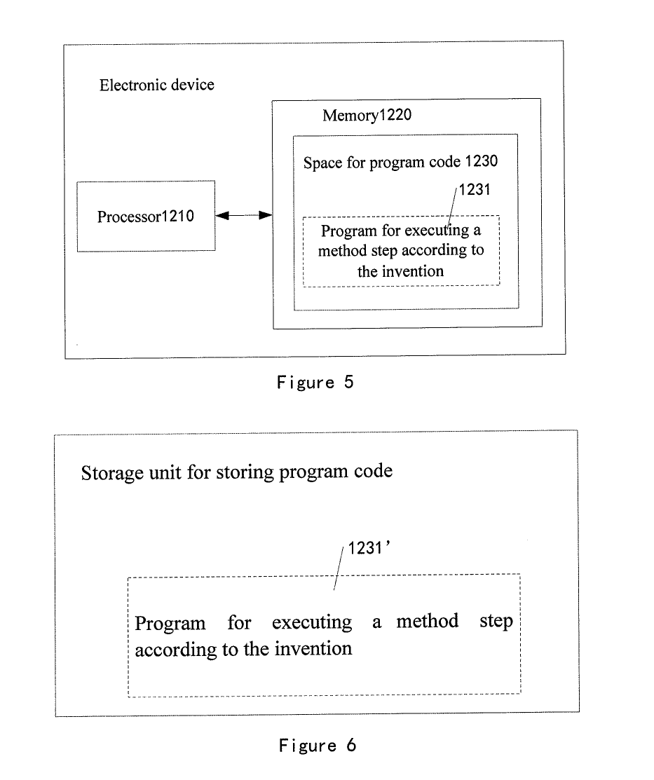

For example, FIG. 5 shows an electronic device which may carry out a method for installing an application program based on an intelligent terminal device of the invention. The electronic device traditionally comprises a processor 1210 and a computer program product or a computer readable medium in the form of a memory 1220. The memory 1220 may be an electronic memory such as a flash memory, an EEPROM (electrically erasable programmable read-only memory), an EPROM, a hard disk or a ROM. The memory 1220 has a memory space 1230 for a program code 1231 for carrying out any method steps in the methods as described above. For example, the memory space 1230 for a program code may comprise individual program codes 1231 for carrying out individual steps in the above methods, respectively. The program codes may be read out from or written to one or more computer program product. These computer program products comprise such a program code carrier as a hard disk, a compact disk (CD), a memory card or a floppy disk. Such a computer program product is generally a portable or stationary storage unit as described with reference to FIG. 6. The storage unit may have a memory segment or a memory space, etc. arranged similarly to the memory 1220 in the electronic device of FIG. 5. The program code may for example be compressed in an appropriate form. In general, the storage unit comprises a program 1231′ for executing method steps according to the invention, i.e., a code which may be read by e.g., a processor such as 1210, and when run by an electronic device, the codes cause the electronic device to carry out individual steps in the methods described above.

“An embodiment”, “the embodiment” or “one or more embodiment” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

In the specification provided herein, a plenty of particular details are described. However, it can be appreciated that embodiments of the invention may be practiced without these particular details. In some embodiments, well known methods, structures and technologies are not illustrated in detail so as not to obscure the understanding of the specification.

It is to be noted that the detailed description of the invention in the above embodiments does not limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. A method for installing an application program based on an intelligent terminal device, comprising:
during installation of an application program, after it is monitored that the application program needs to read a configuration information file, loading an application program authorization permission list interface set for the application program to be installed, wherein the application program authorization permission list interface is an interface for modifying an application program authorization permission list, comprises one or more behavior permission selectively authorized by a user for the application program to be installed, and records modifications to the application program authorization permission list; and
updating the behavior permissions of the application program according to the record of the modifications to the application program authorization permission list after the installation of the application program is completed.

2. The method as claimed in claim 1, wherein the loading an application program authorization permission list interface set for the application program to be installed comprises:
parsing an application program file package for installing the application program to obtain an application program identification in the application program file package;
querying a preset application program authorization permission list library according to the obtained application program identification, to obtain an application program authorization permission list corresponding to the application program identification; and
loading the obtained application program authorization permission list on an installation interface, to generate the application program authorization permission list interface.

3. The method as claimed in claim 2, wherein setting the application program authorization permission list library comprises:
for each application program, during installation of an application program, after it is monitored that the application program reads a configuration information file, collecting and obtaining behavior permissions applied for by the application program to an intelligent terminal device operating system in the configuration information file; and
generating an application program authorization permission list stored in the application program authorization permission list library according to behavior permissions authorized by the user from the obtained behavior permissions applied for by the application program.

4.-8. (canceled)

9. The method as claimed in claim 3, wherein after the obtaining behavior permissions applied for by the application program to the intelligent terminal device operating system in the configuration information file, the method further comprises:
classifying the obtained behavior permissions applied for by the application program into privacy permissions for reminding the user to pay special attention and other permissions to be authorized directly as the application program applies for.

10. The method as claimed in claim 9, further comprising:
dividing the privacy permissions into essential permissions essential to the running of the application program and nonessential permissions optional to the running of the application program, and displaying prompt information of the nonessential permissions to the user on an authorization setting interface.

11. The method as claimed in claim 10, further comprising:
performing verification of legality and rationality on the essential permissions applied for by the application program utilizing an isolation sandbox and/or static code analysis and/or automatic code feature scanning approach, to determine whether each permission in the essential permissions is an indispensable permission necessary for the application program to be run, and if not, removing the permission from the essential permissions and displaying it to the user as a nonessential permission.

12. The method as claimed in claim 1, further comprising:
running a preset secure application program to update the authorized behavior permissions of the application program, such that when the application program is run subsequently, it conducts corresponding access according to the updated authorized behavior permissions.

13. (canceled)

14. The method as claimed in claim 1, wherein before the installation of the application program is completed, the method further comprises:
performing security scanning on an application program file package to be installed corresponding to the application program, and if the application program file package to be installed passes the security scanning, implementing the flow of installing the application program, otherwise, ending the flow.

15.-16. (canceled)

17. The method as claimed in claim 1, wherein the loading an application program authorization permission list interface set for the application program to be installed comprises:
jumping and directing an installation interface provided by an intelligent terminal device operating system to the application program authorization permission list interface via a hook, and ending the jumping of the installation interface provided by the intelligent terminal device operating system after confirming or completing modification to the application program authorization permission list.

18. (canceled)

19. The method as claimed in claim 1, wherein the loading an application program authorization permission list interface set for the application program to be installed comprises:
finding out a class and interface of a hook that needs to be inserted in the configuration information file of the application program in the source code of the framework level of the running platform of the intelligent terminal device;
analyzing and modifying the source code of the class and interface, such that the class and interface of the hook inserted when the configuration information file needs to be read are directed to the application program authorization permission list preset for the application program to be installed; and
running a preset program code segment, and loading the application program authorization permission list to the current installation interface to generate the application program authorization permission list interface.

20.-23. (canceled)

24. The method as claimed in claim 1, further comprising:
installing the application program according to a class and interface of a hook provided by an intelligent terminal device operating system, and not displaying on the installation interface prompt information comprising completion of the installation of the application program; and
after it is monitored that updating behavior permissions granted to the application program with respect to the intelligent terminal device operating system during the installation is completed, displaying on the installation interface prompt information comprising completion of the installation of the application program.

25. An apparatus for installing an application program based on an intelligent terminal device, comprising:
a memory having instructions stored thereon;
a processor configured to execute the instructions to perform following operations:
during installation of an application program, after it is monitored that the application program needs to read a configuration information file,
loading an application program authorization permission list interface set for the application program to be installed according to the received notification, wherein the application program authorization permission list interface is an interface for modifying an application program authorization permission list, comprises one or more behavior permission selectively authorized by a user for the application program to be installed, and records modifications to the application program authorization permission list; and
updating the behavior permissions of the application program according to the record of the modifications to the application program authorization permission list after the installation of the application program is completed.

26. The apparatus as claimed in claim 25, wherein the loading an application program authorization permission list interface set for the application program to be installed comprises:
parsing an application program file package for installing the application program, to obtain an application program identification in the application program file package;
querying a preset application program authorization permission list library according to the obtained application program identification, to obtain an application program authorization permission list corresponding to the application program identification; and
loading the obtained application program authorization permission list on an installation interface, to generate the application program authorization permission list interface.

27. The apparatus as claimed in claim 26, wherein after the obtaining behavior permissions applied for by the application program to the intelligent terminal device operating system in the configuration information file, the operations further comprise:
a classifying the obtained behavior permissions applied for by the application program into privacy permissions for reminding the user to pay special attention and other permissions to be authorized directly as the application program applies for.

28. The apparatus as claimed in claim 27, wherein the operations further comprise:
dividing the privacy permissions into essential permissions essential to the running of the application program and nonessential permissions optional to the running of the application program, and displaying prompt information of the nonessential permissions to the user on an authorization setting interface.

29. The apparatus as claimed in claim 27, wherein the operations further comprise:
performing verification of legality and rationality on the essential permissions applied for by the application program utilizing an isolation sandbox and/or static code analysis and/or automatic code feature scanning approach, to determine whether each permission in the essential permissions is an indispensable permission necessary for the application program to be run, and if not, removing the permission from the essential permissions and display displaying it to the user as a nonessential permission.

30. (canceled)

31. The apparatus as claimed in claim 25, wherein the operations further comprise:
running a preset secure application program to update the authorized behavior permissions of the application program, such that when the application program is run subsequently, it conducts corresponding access according to the updated authorized behavior permissions.

32. The apparatus as claimed in claim 25, wherein before the installation of the application program is completed, the operations further comprise:
performing security scanning on an application program file package to be installed, and if the application program file package to be installed passes the security scanning, implementing the flow of installing the application program file package, otherwise, end the ending the flow.

33. The apparatus as claimed in claim 26, wherein the loading an application program authorization permission list interface set for the application program to be installed comprises:
finding out a class and interface of a hook that needs to be inserted in the configuration information file of the application program in the source code of the framework level of the running platform of the intelligent terminal device,
analyzing and modifying the source code of the class and interface, such that the class and interface of the hook inserted when the configuration information file needs to be read are directed to the application program authorization permission list preset for the application program to be installed; and
running a preset program code segment, and loading the application program authorization permission list to the current installation interface to generate the application program authorization permission list interface.

34.-42. (canceled)

43. A non-transitory computer readable medium having instructions stored thereon that, when executed by at least one processor, cause the at least one processor to perform following operations:
during installation of an application program, after it is monitored that the application program needs to read a configuration information file, loading an application program authorization permission list interface set for the application program to be installed, wherein the application program authorization permission list interface is an interface for modifying an application program authorization permission list, comprises one or more behavior permission selectively authorized by a user for the application program to be installed, and records modifications to the application program authorization permission list; and
updating the behavior permissions of the application program according to the record of the modifications to the application program authorization permission list after the installation of the application program is completed.
